(19) United States
(12) Patent Application Publication
(10) Pub. No.: US 2025/0220142 A1
(43) Pub. Date: Jul. 3, 2025

(54) THINNESS SCREEN MAGNIFICATION DISPLAY DEVICE

(71) Applicant: Far Vision Technology CO., LTD., Taichung City (TW)

(72) Inventor: Stephen CHEN, Taichung City (TW)

(21) Appl. No.: 18/677,731

(22) Filed: May 29, 2024

(30) Foreign Application Priority Data
Jan. 2, 2024 (TW) 113100002

(51) Int. Cl. H04N 9/31

(52) U.S. Cl. CPC H04N 9/3185; H04N 9/3141

(57) ABSTRACT

A thinness screen magnification display device is provided and includes a processor, a display module electrically connected to the processor and an optical module. The processor is configured to receive an input image and to form an output image to display the output image on the display module. The optical module receives, reflects and magnifies the output image to form a projecting image. The processor extends the input image along the longitudinal direction to form the output image, and by the optical module, the magnifying scale of the output image in the longitudinal direction is greater than the magnifying scale of the output image in the transversal direction so that the aspect ratio of the projecting image is equal to the aspect ratio of the input image. By the two-stage magnification with the different magnifying scales, the size of the displaying device may be miniaturized, but the magnifying scale of the aspect ratio remains the same.

### FIELD OF THE INVENTION

The present disclosure relates to a screen magnification display device, and more precisely, relates to a thinness screen magnification display device for correcting, controlling, and slowing down short-sightedness.

### BACKGROUND OF THE INVENTION

Because of popularization of cell phones, tablets, books and toys, a rise of short-sightedness proportion in children is a problem which each country confronts. In addition to genetic factors, the main reason for the short-sightedness is long-term use of eyes at close distances.

Ophthalmologists usually suggest keeping 30 centimeters between a book and the eyes when the children read the book and write and keeping 60 centimeters between a computer and the eyes when the children use the computer, but the 30 centimeters and the 60 centimeters are not standards, and there is no need to keep 30 centimeters between the book and the eyes and to keep 60 centimeters between the computer and the eyes for eye health. Honestly, due to the limitations of the operation distances and a user does not clearly see the text and the patterns on the book and a screen when the foregoing distances are too long, the suggestion as stated by the ophthalmologists is generated. If the operation distances may not be limited, for example, when the user utilizes a mouse to manipulate the computer, the screen may be disposed farther than the book because the text and the patterns may be magnified. In this way, no matter what the situation is reading the book or using the screen, the more farther the visual distance is, the more beneficial it is for the eye health.

Shortening the time for seeing near objects indicates that the time of working hard must be reduced, and it may bring about a risk of deterioration in the academic performance of the children, but forbidding the children to play the cell phone exploits the spare time of the children, and there is an unrealistic difficulty; the selection which does not affect the academic performance and the spare time of the children is extending the visual distance between the book and the eyes when the children read the book and write. However, the distinguishable ability of the eyes would deteriorate and eyes fatigue easily happens after the long extension of the visual distance unless the text and the image are magnified. Moreover, the long visual distance may beyond a manipulation range of hands, and the limitation of the visual distance when the children naturally read the book and write is about 40 centimeters. Hence, it is necessary to get assistance from new technologies to extend the visual distance.

As shown in FIG. 1, TWM569860U discloses a screen magnification display device including a support base, a display module 2, a reflective sheet 36 and a magnifying sheet 37. The optical path of forming virtual images serving as a concave mirror magnifies the image of the display module 2 by several times and forms the magnified image of the display module 2 at a position of which a distance is several times longer than an object distance. The display module 2 is connected to an electronic product by an input interface and magnifies and displays the image stored in the interior of the electronic product to alleviate the eyes fatigue. However, the foregoing optical path of forming virtual images limits an input image source to electronic data from data lines or memory cards, etc.

### SUMMARY OF THE INVENTION

The object of the present disclosure is to provide a thinness screen magnification display device which optimizes a projecting optical path. In addition, the thinness screen magnification display device provided by the present disclosure further utilizes an image capturing unit to capture an image of the screen on a mobile phone or a computer or text on a book to see so that a user can see an expected magnification image and eyes fatigue is alleviated.

In light of the aforementioned object, the present disclosure provides the thinness screen magnification display device including a processor, a display module and an optical module. The processor is configured to receive an input image and to form an output image. The display module is electrically connected to the processor and displays the output image and is provided with a transversal direction and a longitudinal direction. The optical module receives, reflects and magnifies the output image to form a projecting image. The processor extends the input image along the longitudinal direction to form the output image, and by the optical module, the magnifying scale of the output image in the longitudinal direction is greater than the magnifying scale of the output image in the transversal direction so that the aspect ratio of the projecting image is equal to the aspect ratio of the input image.

By the aforementioned configuration, the short side of the display module may be significantly shortened.

Preferably, the optical module includes an upper shell and a lower shell. The output image is projected on the inner side of the upper shell and then is projected on the inner side of the lower shell by the inner side of the upper shell, and the output image is projected outside by the inner side of the lower shell to form the projecting image. One of a reflective sheet and a magnifying sheet is disposed on the inner side of the upper shell and the other of the reflective sheet and the magnifying sheet is disposed on the inner side of the lower shell.

Preferably, one end of the upper shell is connected to one end of the lower shell by an axle parallel to the transversal direction.

Preferably, the magnifying sheet is a concave mirror or a freeform mirror, and the reflective sheet is one of a flat mirror, the concave mirror, a convex mirror and the freeform mirror.

Preferably, the processor is electrically connected to a wireless transmission unit and/or an input interface.

Preferably, the processor is configured to adjust the optical distortion of the projecting image.

Preferably, the optical module includes an image capturing unit electrically connected to the processor, and the camera of the image capturing unit faces outside.

Preferably, the upper shell includes an image capturing unit, and the camera of the image capturing unit faces a scene in the area below the lower shell or faces a scene in the area below and in front of the lower shell.

Preferably, one end of the optical module has a flat for mounting display module, and the flat is formed by extending along the longitudinal direction.

Preferably, the projecting direction of the output image intersects the projecting direction of the projecting image.

### THE DRAWINGS

FIG. 1 is a schematic diagram of prior art.

FIG. 2 is an appearance schematic diagram of a thinness screen magnification display device.

FIG. 3 is a cross section view diagram of a thinness screen magnification display device.

FIG. 4 is an image adjustment schematic diagram of a thinness screen magnification display device.

FIG. 5 is a system diagram of a thinness screen magnification display device.

FIG. 6 and FIG. 7 are schematic diagrams of a projecting optical path of a thinness screen magnification display device.

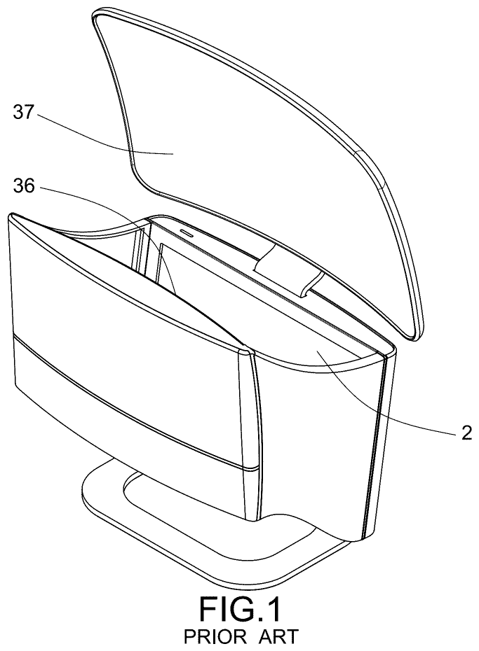

### DETAILED DESCRIPTION

In the following description, a projection direction of light of a projecting image D3 formed by an optical module is defined as a front (i.e., a positive direction of y-axis as follows) to have better understanding on the present disclosure.

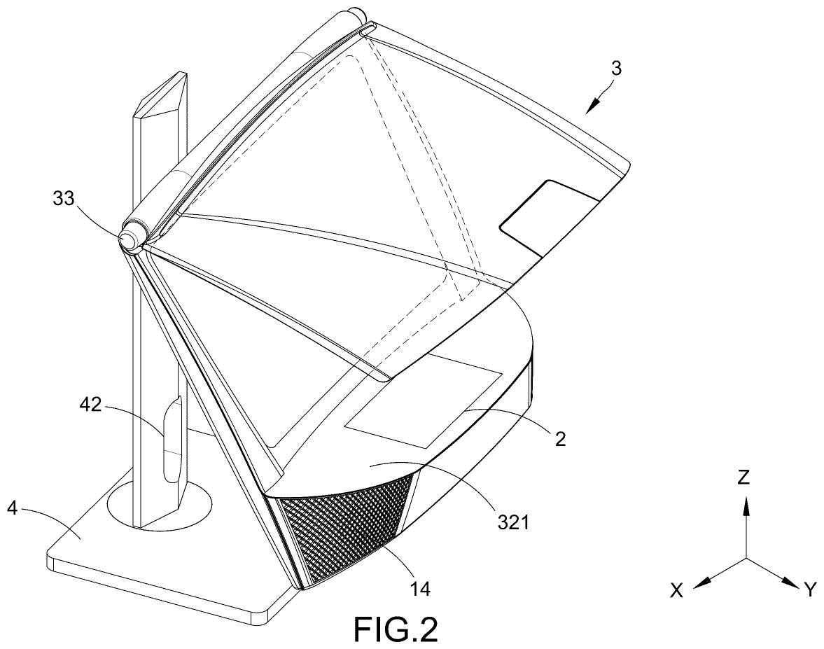

A thinness screen magnification display device as shown in FIG. 2 to FIG. 6 includes a processing module, a display module 2, and an optical module 3.

The processing module and the other electronic components are integrated in a circuit board 1, and the processing module has an graphics processing unit (GPU) serving as a processor 11 to receive an input image D1 and to form an output image D2.

The display module 2 is electrically connected to the processor 11 and displays a 2D output image D2. The display module 2 has a rectangular boundary, and for easy understanding, the length direction of the display module 2 (i.e., a transversal direction in the following description) and the width direction of the display module 2 (i.e., a longitudinal direction in the following description) are respectively expressed as X-direction and Y-direction, and in other words, XY plane is parallel to the image projection plane of the display module 2.

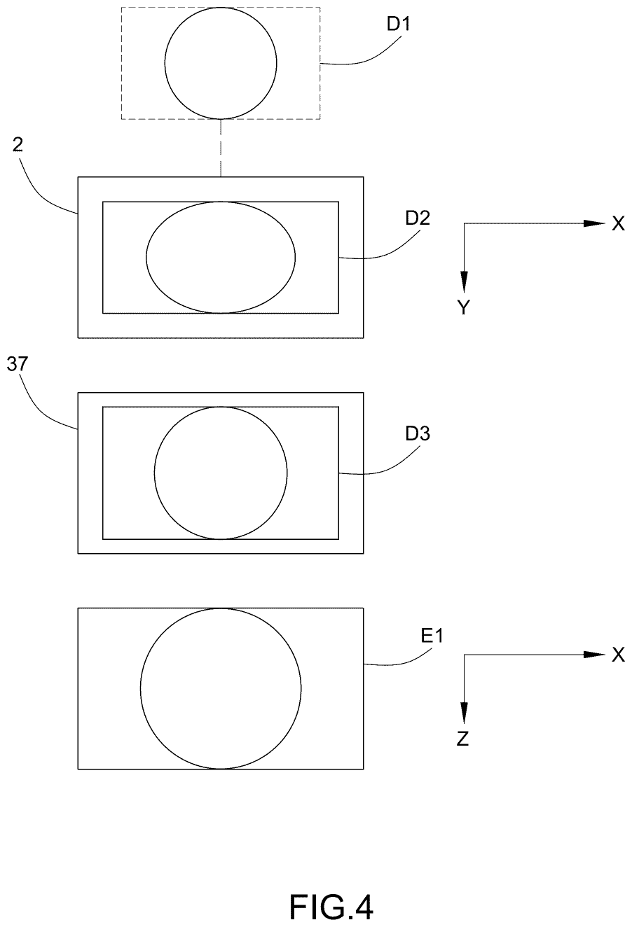

The optical module 3 receives and magnifies the output image D2 to form a projecting image D3 projecting on eyes E. The projecting image D3 is provided with the transversal direction and the longitudinal direction respectively corresponding to the X-direction and the Y-direction. Please refer to FIG. 4. By the magnification optical path L of the optical module 3, the length direction and the width direction of the output image D2 on the display module 2 respectively correspond to the transversal direction and the longitudinal direction of the projecting image D3.

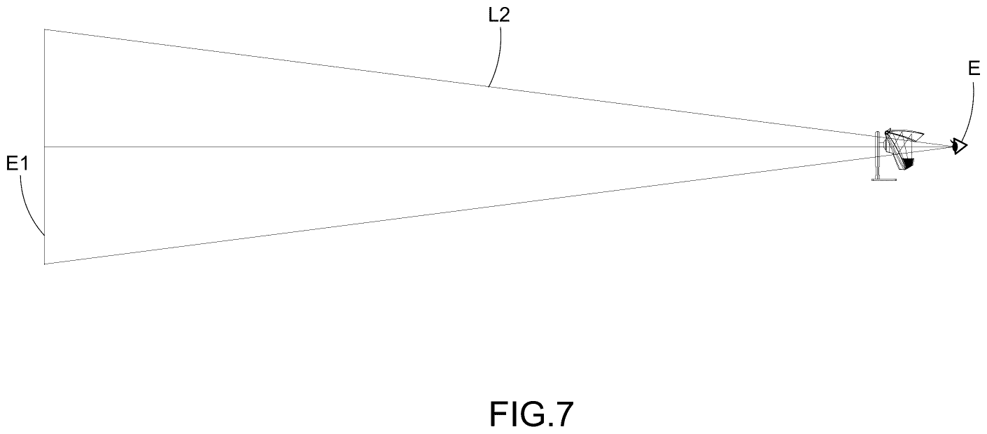

In some embodiments, the processor 11 extends the input image D1 along the longitudinal direction to form the output image D2. By the optical path of the optical module 3, the magnifying scale of the output image D2 in the longitudinal direction is greater than the magnifying scale of the output image D2 in the transversal direction so that the aspect ratio of the projecting image D3 on the longitudinal direction and the transversal direction of an image plane E1 (as shown in FIG. 7) is at least same to aspect ratio of the input image D1.

In one embodiment, when the aspect ratio of the input image D1 is 16:9, the output image D2 may be extended along the longitudinal direction, and for example, the aspect ratio of the output image D2 may be adjusted as 19:9, or the output image D2 may be further adjusted until the output image D2 covers the boundary of one of the transversal direction and the longitudinal direction of the display module 2. Because the magnifying scale of the output image D2 in the longitudinal direction is greater than the magnifying scale of the output image D2 in the transversal direction in the optical module 3, the aspect ratio of the output image D2 may be adjusted as 19:10.69 for example and finally, the aspect ratio of the projecting image D3 goes back to 16:9 and is the same as the aspect ratio of the input image D1.

It is worthy to mention that the processor 11 is also configured to adjust the optical distortion generated by the projecting image D3 after the magnification of the optical path and the revealed scene of the output image D2 is adjusted accordingly.

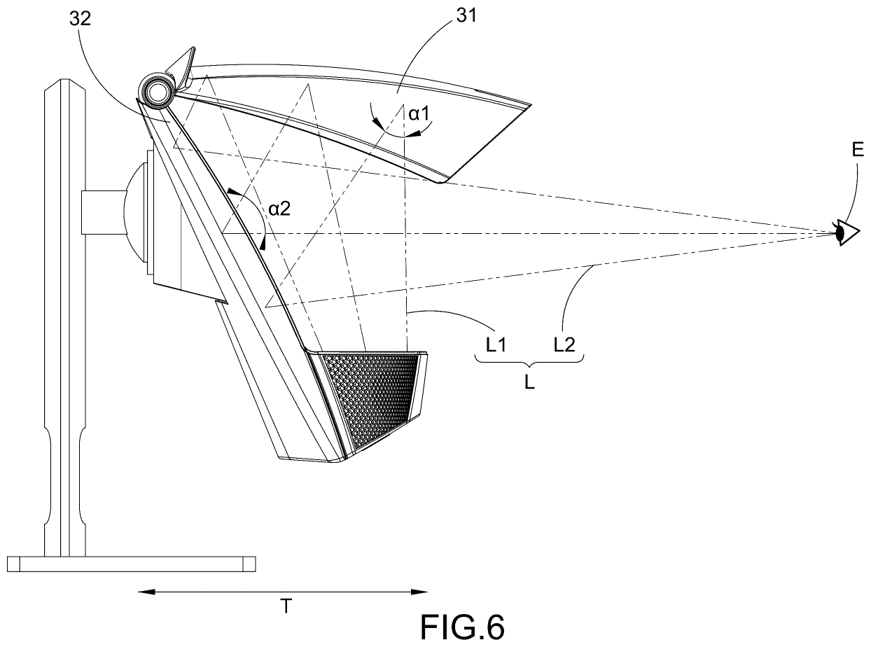

By the magnification optical path with the aforementioned two-stage adjustment, the width of the display module 2 on the longitudinal direction of may be minified, in other words, the width of the display module 2 on the width direction of the display module 2 may become narrower, and a flat 321 where the display module 2 is mounted is correspondingly minified so that the entire thickness T (as shown in FIG. 6) of the magnification displaying device with a thin screen may become thinner.

In some embodiments, the projecting optical path is built under the consideration of the manipulation and the convenience of the optical path. Specifically, the optical module 3 includes an upper shell 31, a lower shell 32 and a first axle parallel to the transversal direction (the X-direction). The upper shell 31 and the lower shell 32 define an accommodation space therebetween, and a reflective sheet 36 and a magnifying sheet 37 are respectively disposed on the inner side of the upper shell 31 and the inner side of the lower shell 32, and the reflective sheet 36 and the magnifying sheet 37 are all located on the interior of the accommodation. The magnifying sheet 37 may be a concave mirror or a freeform mirror, and the reflective sheet 36 may be a flat mirror, the concave mirror, a convex mirror or the freeform mirror, and the output image D2 is transformed into the projecting image D3 by the magnification and the reflection of the reflective sheet 36 and the magnifying sheet 37. Besides, the magnifying sheet 37 may be configured to cancel the image distortion of the reflective sheet 36.

The first axle 33 is used to be pivotably connected to one end of the upper shell 31 and one end of the lower shell 32 so that the other end of the upper shell 31 can swing up and down relative to the lower shell 32. Besides, in some embodiments, the end of the lower shell 32 far away from the first axle 33 protrudes forward to form the flat 321, and the upper surface of the flat 321 overlaps the XY plane to mount the display module 2, and the magnifying sheet 37 is inclined backward relative to the projection surface of the display module 2.

When the other end of the upper shell 31 swings down to be positioned on the shell boundary of the lower shell 32, the upper shell 31 covers the top of the flat 321. Afterwards, the accommodation space is closed and accommodates the display module 2.

When the other end of the upper shell 31 swings up at a preset angle, the reflective sheet 36 is located above the projection surface of the display module 2 and the projecting optical path is built by the display module 2, the reflective sheet 36 and the magnifying sheet 37. Please refer to FIG. 6. From the view of YZ plane, the reflective sheet 36 is parallel to the display module 2, and the angle α1 between the incident light and the reflective light of the projecting optical path of the center of the display module 2 on the reflective sheet 36 is less than 60 degrees and the angle α2 between the incident light and the reflective light of the projecting optical path of the center of the reflective sheet 36 on the magnifying sheet 37 is not greater than 60 degrees so that the projecting direction of the output image D2 intersects the projecting direction of the projecting image D3. As a result, the output image D2 after the aforementioned double reflection projects forward on the eyes E of the user. This folded optical path is also beneficial to decrease the entire thickness T of the thinness screen magnification display device.

Because the configuration of the projecting optical path has been optimized, the distance and the projection angle between the display module 2, the reflective sheet 36 and the magnifying sheet 37 do not need adjusting when the user uses the thinness screen magnification display device, and an axle (a second axle 41) only needs fine-tuning according to the figure of the user and the viewing position of the eyes so that the user may easily obtain an optimized viewing angle.

In some embodiments, the base 4 includes a holding part 42 for the user to easily move the thinness screen magnification display device. The second axle 41 is disposed on the back surface of the optical module 3, and for example, the second axle 41 is disposed on the outer side of the lower shell 32 and is located on the back surface of the magnifying sheet 37, and the second axle 41 is used to set or fine-tune the projection angle of the image projected by the optical module 3. In addition, a slide proof pad (not shown in figures) is disposed on the bottom of the base 4 to prevent the thinness screen magnification display device from sliding.

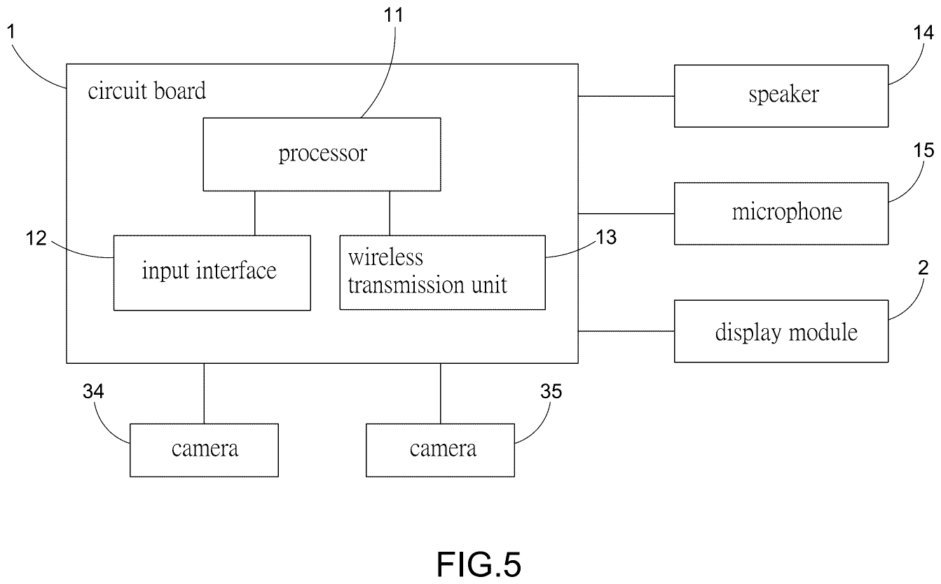

In some embodiments, the optical path configuration of the thinness screen magnification display device may be allowed to contain extra extension components. As shown in FIG. 5, the circuit board 1 further includes an input interface 12 electrically connected to the processor 11, and the input interface 12 may include slots for HDMI, DVI, Display Port, D-SUB, USB, SD card, etc. The circuit board 1 may further include a wireless transmission unit 13, and the wireless transmission unit 13 such as a Bluetooth transceiver or a WIFI transceiver is electrically connected to the processor 11 and receives images or audio signals inputted by an external electronic device, and the aforementioned images may serve as the input image D1 of the processor 11.

In some embodiments, the thinness screen magnification display device further includes a speaker 14, and the speaker 14 is electrically connected to the processor 11 and is used to play the audio signals of the input image D1 or the pure audio signals inputted by the external electronic device. Alternatively, the thinness screen magnification display device further includes a microphone 15, and the microphone 15 is electrically connected to the processor 11 and is used to receive the audio signals such as the voice of the user.

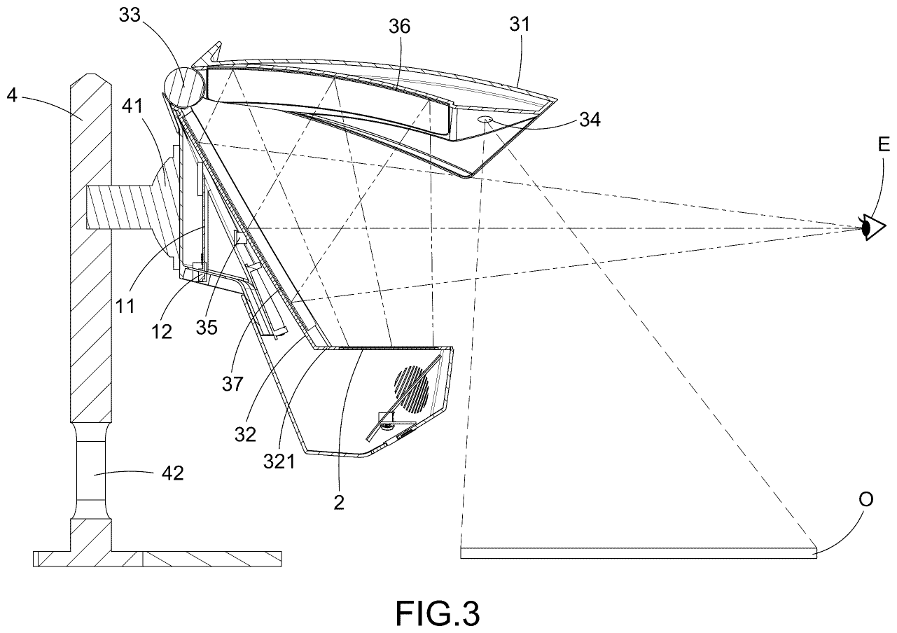

Please refer to FIG. 3 and FIG. 5. The optical module 3 further includes at least one image capturing unit electrically connected to the processor 11. As an example, the camera 34 of the image capturing unit may be disposed on the front of the optical module 3, and for example, the camera 34 of the image capturing unit is disposed on the upper shell 31 and is adjacent to the shell boundary of the upper shell 31. The camera 34 of the image capturing unit is used to capture the scene in the area below the lower shell 32 or the scene in the area below and in front of the lower shell 32.

Hence, the user may place the object O to display such as the book or the smart phone in the field of view of the camera 34, and the image of the object O displayed by display module 2 is projected on the image plane E1.

On the basis of the aforementioned configuration, because the lower shell 32 is inclined relative to the base 4, the camera 34 is located above and in front of the lower shell 32 when the upper shell 31 swings up to be parallel to the display module 2, and the field of view of the camera 34 would not be hidden by the lower shell 32. In the other embodiments, the camera for capturing the object O may be disposed in front of or below the lower shell 32, and it may have similar effects.

In some embodiments, image capturing unit further includes a hidden camera 35, and the hidden camera 35 is electrically connected to the processor 11 and is in back of the magnifying sheet 37. The field of view of the hidden camera 35 faces outside, and for example, the hidden camera 35 may shoot the scene in front of the hidden camera 35 to capture the image of the user.

As shown in FIG. 3, FIG. 4, FIG. 6 and FIG. 7, the projecting optical path may be divided into a reflection optical path L1 and a magnification optical path L2 for forming virtual images. When the thinness screen magnification display device is used, the input image D1 is obtained from the input interface 12, the wireless transmission unit 13 or the camera 34 and the processor 11 receives the input image D1 and the display module 2 displays the output image D2. As shown in the reflection optical path L1, the output image D2 is projected on the reflective sheet 36 located on the inner side of the upper shell 31 and then is projected on the magnifying sheet 37 located on the inner side of the lower shell 32 by the reflective sheet 36, and the output image D2 is projected outside by the magnifying sheet 37 to form the projecting image D3, and the projecting image D3 is projected on the eyes E of the user. The projecting image D3 actually experienced by the user is magnified by the magnification optical path L2 and is formed on the faraway image plane E1.

In the other embodiments, the magnifying sheet and the reflective sheet are respectively disposed on the upper shell and the lower shell, and it has similar effects.

As described above, in the principle of imaging a virtual image by concave mirrors, the thinness screen magnification display device magnifies the object image by several times and the magnified object image is formed at the position of which the distance is several times longer than the object distance so that the eyes of the user may see the magnified image seen with the visual distance beyond 7 meters and the user would not have the short-sightedness due to the long-term use of eyes at the close distances.

It is worthy to mention that the entire thickness T of the thinness screen magnification display device on the X-direction is merely associated with the height direction (Z-direction) of the image. By the optical configuration of the two-stage magnification with the different magnifying scales on the input image D1, the entire thickness T of the display module of which the aspect ratio is 21:9 may be set within 30 centimeters so that mobile phone users, computer users and book users would not have the short-sightedness due to the long-term use of eyes at the close distances to decrease the burdens of the eyes. At the same time, the thinness screen magnification display device provided by the present disclosure may be connected to a mobile, a computer, a video player, a USB disk, a memory card to see the image of the external electronic device with the magnification view and expand the application range of the thinness screen magnification display device.

### List Of Reference Signs

1: circuit board
11: processor
12: input interface
13: wireless transmission unit
14: speaker
15: microphone
2: display module
3: optical module
31: upper shell
32: lower shell
321: flat
33: first axle
34,35: camera
36: reflective sheet
37: magnifying sheet
4: base
41: second axle
42: holding part
D1: input image
D2: output image
D3: projecting image
E: eyes
E1: image plane
L1, L2, L: optical path
O: object
α1, α2: angle

1. A thinness screen magnification display device comprising:
a processor configured to receive an input image and to form an output image according to the input image;
a display module electrically connected to the processor, displaying the output image and provided with a transversal direction and a longitudinal direction; and
an optical module receiving, reflecting and magnifying the output image to form a projecting image;
wherein, the processor extends the input image along the longitudinal direction to form the output image, and by the optical module, a magnifying scale of the output image in the longitudinal direction is greater than a magnifying scale of the output image in the transversal direction so that an aspect ratio of the projecting image is equal to an aspect ratio of the input image.

2. The thinness screen magnification display device according to claim 1, wherein the optical module comprises an upper shell and a lower shell, the output image is projected on an inner side of the upper shell and then is projected on an inner side of the lower shell by the inner side of the upper shell, and the output image is projected outside by the inner side of the lower shell to form the projecting image, and one of a reflective sheet and a magnifying sheet is disposed on the inner side of the upper shell and the other of the reflective sheet and magnifying sheet is disposed on the inner side of the lower shell.

3. The thinness screen magnification display device according to claim 2, wherein one end of the upper shell is connected to one end of the lower shell by an axle parallel to the transversal direction.

4. The thinness screen magnification display device according to claim 2, wherein the magnifying sheet is a concave mirror or a freeform mirror, and the reflective sheet is one of a flat mirror, the concave mirror, a convex mirror and the freeform mirror

5. The thinness screen magnification display device according to claim 1, wherein the processor is electrically connected to a wireless transmission unit and/or an input interface.

6. The thinness screen magnification display device according to claim 1, wherein the processor is configured to adjust optical distortion of the projecting image.

7. The thinness screen magnification display device according to claim 1, wherein the optical module comprises an image capturing unit electrically connected to the processor, and a camera of the image capturing unit faces outside.

8. The thinness screen magnification display device according to claim 2, wherein the optical module comprises an image capturing unit disposed on the upper shell, and a camera of the image capturing unit faces a scene in the area below the lower shell or faces a scene in the area below and in front of the lower shell.

9. The thinness screen magnification display device according to claim 1, wherein one end of the optical module has a flat for mounting display module, and the flat is formed by extending along the longitudinal direction.

10. The thinness screen magnification display device according to claim 1, wherein a projecting direction of the output image intersects a projecting direction of the projecting image.
